(19) United States
(12) Patent Application Publication
(10) Pub. No.: US 2025/0123546 A1
(43) Pub. Date: Apr. 17, 2025

(54) WAVELENGTH CONVERTING APPARATUS, LIGHT SOURCE APPARATUS, AND PROJECTOR

(71) Applicant: SEIKO EPSON CORPORATION, Tokyo (JP)

(72) Inventors: Norikazu KOMATSU, Suwa-shi (JP); Akira EGAWA, Shiojiri-shi (JP); Ayumu KOBAYASHI, Matsumoto-shi (JP); Toru ISHIDA, Matsumoto-shi (JP)

(73) Assignee: SEIKO EPSON CORPORATION, Tokyo (JP)

(21) Appl. No.: 18/913,270

(22) Filed: Oct. 11, 2024

(30) Foreign Application Priority Data
Oct. 13, 2023 (JP) 2023-177821
Oct. 13, 2023 (JP) 2023-177822

(51) Int. Cl. G03B 21/20

(52) U.S. Cl. CPC G03B 21/204; G03B 21/2066

(57) ABSTRACT

A wavelength converting apparatus includes a base made of one of copper and a copper alloy; a copper oxide layer formed at a first surface of the base; a joining reinforcing layer being a tin oxide layer which contains tin oxide and is layered at the copper oxide layer; a joining layer disposed at the joining reinforcing layer; and a wavelength converter disposed at the joining layer.

The present application is based on, and claims priority from JP Application Serial Number 2023-177821, filed Oct. 13, 2023 and JP Application Serial Number 2023-177822, filed Oct. 13, 2023, the disclosures of which are hereby incorporated by reference herein in their entirety.

### BACKGROUND

### 1. Technical Field

The present disclosure relates to a wavelength converting apparatus, a light source apparatus, and a projector.

### 2. Related Art

There is a known projector including an illuminator that outputs illumination light, a color separation system that separates red light, green light, and blue light from the illumination light, three light modulating apparatuses that modulate the three types of separated color light, respectively, a light combining system that combines the three types of modulated color light, and a projection optical apparatus that projects the combined image light (see JP-A-2021-144163, for example).

The illuminator of the projector described in JP-A-2021-144163 includes a first light source section that outputs excitation light having a first wavelength band and a wavelength converter that converts the excitation light incident thereon into fluorescence having a second wavelength band different from the first wavelength band.

The wavelength converter includes a wavelength converting layer, a first substrate, a first intermediate layer, a second substrate, and a second intermediate layer. The first substrate, the first intermediate layer, the wavelength converting layer, the second intermediate layer, and the second substrate are stacked in this order from the excitation light incident side.

The first substrate is configured with a ceramic heat dissipating substrate.

The first intermediate layer is provided between the wavelength conversion layer and the first substrate. The first intermediate layer is configured with a first joining layer provided at a first surface of the wavelength converting layer and a second joining layer provided at the first substrate. The first joining layer and the second joining layer are each made of a siloxane compound having high light transmittance.

The wavelength converting layer receives the excitation light and outputs the fluorescence. The wavelength converting layer includes a phosphor layer, a total reflection layer, an enhanced reflection layer, a first degradation preventing layer, a reflection layer, and a second degradation preventing layer.

The second intermediate layer is configured with a silver layer and a nanosilver layer, and bonds the second substrate and the wavelength converting layer to each other.

The second substrate is configured, for example, with a metal heat dissipating substrate made of copper.

JP-A-2021-144163 is an example of the related art.

In the wavelength converting apparatus described in JP-A-2021-144163, however, the second substrate made of copper and the wavelength converting layer are bonded to each other via the second intermediate layer configured with the silver layer and the nanosilver layer. The configuration described above has a problem of difficulty increasing the strength of the joining between the copper substrate and the wavelength converting layer.

There has therefore been a demand for a configuration that allows a further increase in the joining strength and hence an increase in the quality of the wavelength converting apparatus.

### SUMMARY

A wavelength converting apparatus according to a first aspect of the present disclosure includes: a base made of one of copper and a copper alloy; a copper oxide layer formed at a first surface of the base; a joining reinforcing layer being a tin oxide layer which contains tin oxide and is layered at the copper oxide layer; a joining layer disposed at the joining reinforcing layer; and a wavelength converter disposed at the joining layer.

A wavelength converting apparatus according to another aspect of the present disclosure includes: a substrate having a first surface and made of one of copper and a copper alloy; a diffusion suppressing layer containing tin oxide and disposed at the first surface; a joining layer disposed at the diffusion suppressing layer; and a wavelength converter disposed at the joining layer.

A light source apparatus according to a second aspect of the present disclosure includes: a solid-state light source configured to emit excitation light; and the wavelength converting apparatus according to one of the above aspects described above configured to convert a wavelength of the excitation light.

A projector according to an aspect of the present disclosure includes: the light source apparatus according to the second aspect described above; an image light generating apparatus configured to generate image light from light emitted from the light source apparatus; and a projection optical apparatus configured to project the generated image light.

### BRIEF DESCRIPTION OF THE DRAWINGS

FIG. 1 is a diagrammatic view showing the configuration of a projector according to a first embodiment.

FIG. 2 is a diagrammatic view showing the configuration of a light source apparatus in the first embodiment.

FIG. 3 is a cross-sectional view showing a wavelength converting apparatus according to the first embodiment.

FIG. 4 is a graph showing the relationship between the ratio of the amount of substance of oxygen to the amount of substance of tin in a joining reinforcing layer in the first embodiment and the tensile strength.

FIG. 5 is a graph showing the relationship between the thickness of the joining reinforcement layer and the tensile strength of the portion between the joining reinforcement layer and a joining layer in the first embodiment.

FIG. 6 shows a result of analysis of the components in the wavelength converting apparatus according to the first embodiment.

FIG. 7 is a cross-sectional view showing a wavelength converting apparatus according to a second embodiment.

FIG. 8 shows a result of the analysis of the components in the wavelength converting apparatus according to the second embodiment.

FIG. 9 shows an SEM image of a part of a cross section of a sample in the second embodiment.

FIG. 10 shows an SEM image of a part of a cross section of the wavelength converting apparatus according to the second embodiment.

FIG. 11 is a graph showing the relationship between the ratio of the amount of substance of oxygen to the amount of substance of tin in a diffusion suppressing layer in the second embodiment and the tensile strength.

### DESCRIPTION OF EMBODIMENTS

### First Embodiment

A first embodiment of the present disclosure will be described below with reference to the drawings.

### Schematic Configuration of Projector

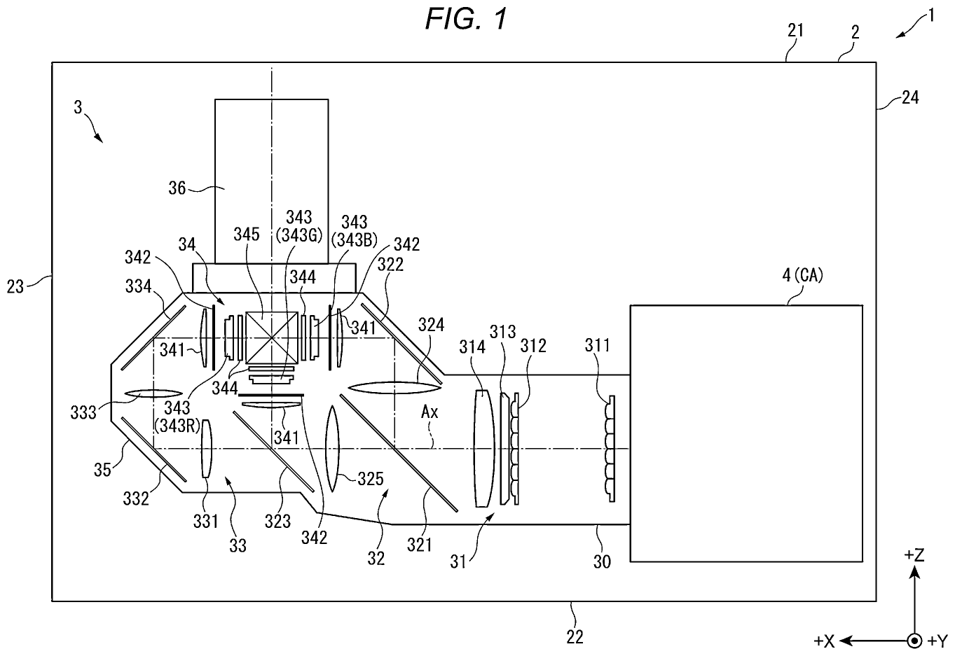

FIG. 1 is a diagrammatic view showing the configuration of a projector 1 according to the present embodiment.

The projector 1 according to the present embodiment projects image light according to image information. The projector 1 includes an exterior enclosure 2 and an image projecting apparatus 3 housed in the exterior enclosure 2, as shown in FIG. 1. In addition, the projector 1 includes, although not shown, a control apparatus that controls the operation of the projector 1, a power supply apparatus that supplies electronic parts of the projector 1 with electric power, and a cooling apparatus that cools cooling targets in the projector 1.

### Configuration of Exterior Enclosure

The exterior enclosure 2 includes a front surface section 21, a rear surface section 22, a left side surface section 23, a right side surface section 24, and a top surface section, and a bottom surface section, the latter two of which are not shown, and is formed in a substantially rectangular-box-like shape as a whole.

The front surface section 21 and the rear surface section 22 constitute surfaces of the exterior enclosure 2 that are opposite from each other. The front surface section 21 has an opening that exposes a light-exiting-side end portion of a projection optical apparatus 36, which will be described later.

The left side surface section 23 and the right side surface section 24 constitute surfaces of the exterior enclosure 2 that are opposite from each other. The top surface section and the bottom surface section constitute surfaces of the exterior enclosure 2 that are opposite from each other.

It is assumed in the description below that three directions perpendicular to one another are called +X, +Y, and +Z directions. It is further assumed that the +Z direction is the direction from the rear surface section 22 toward the front surface section 21, that the +X direction is the direction from the right side surface section 24 toward the left side surface section 23, and that the +Y direction is the direction from the bottom surface section toward the top surface section. Although not shown, it is assumed that the opposite direction of the +X direction is a −X direction, that the opposite direction of the +Y direction is a −Y direction, and that the opposite direction of the +Z direction is a −Z direction. It is further assumed that an axis along the +X direction is an X-axis, that an axis along the +Y direction is a Y-axis, and that an axis along the +Z direction is a Z-axis.

### Configuration of Image Projecting Apparatus

The image projecting apparatus 3 forms image light according to input image information and projects the formed image light. The image projecting apparatus 3 includes a light source apparatus 4, an image light generating apparatus 30, and the projection optical apparatus 36.

The light source apparatus 4 outputs illumination light to a homogenizing system 31. The configuration of the light source apparatus 4 will be described later in detail.

The image light generating apparatus 30 generates image light from the illumination light output from the light source apparatus 4. The image light generating apparatus 30 includes the homogenizing system 31, a color separation system 32, a relay system 33, light modulating apparatuses 34, and an optical part enclosure 35.

The homogenizing system 31 homogenizes the illumination light output from the light source apparatus 4. The homogenized illumination light travels via the color separation system 32 and the relay system 33 and illuminates modulation regions of light modulators 343, which will be described later. The homogenizing system 31 includes two lens arrays 311 and 312, a polarization converter 313, and a superimposing lens 314.

The color separation system 32 separates the illumination light incident from the homogenizing system 31 into red light, green light, and blue light. The color separation system 32 includes two dichroic mirrors 321 and 323, a reflection mirror 322, which reflects the blue light separated by the dichroic mirror 321, a lens 324 disposed between the dichroic mirror 321 and the reflection mirror 322, and a lens 325 disposed between the dichroic mirrors 321 and 323.

The relay system 33 is provided in the optical path of the red light, which is longer than the optical paths of the other color light, and suppresses loss of the red light. The relay system 33 includes a light-incident-side lens 331, a relay lens 333, and reflection mirrors 332 and 334. It is assumed in the present embodiment that the red light is guided to the relay system 33, but not necessarily. For example, the blue light may have an optical path longer than those of the other color light and may be guided to the relay system 33.

The light modulating apparatuses 34 modulate the variety of kinds of color light, the red light, the green light, and the blue light incident thereon and combines the variety of kinds of modulated color light with one another to form the image light. The light modulating apparatuses 34 include three field lenses 341, three light-incident-side polarizers 342, three light modulators 343, and three light-exiting-side polarizers 344, which are all provided in accordance with the variety of kinds of incident color light, and one light combining system 345.

The light modulators 343 modulate the light from the light source apparatus 4 to form the image light. Specifically, the light modulators 343 modulate the variety of color light incident via the light-incident-side polarizers 342 in accordance with image signals and output the variety of kinds of modulated color light. The three light modulators 343 include a light modulator 343R, which modulates the red light, a light modulator 343G, which modulates the green light, and a light modulator 343B, which modulates the blue light. The light modulators 343 can each, for example, be a transmissive liquid crystal panel.

The light combining system 345 combines the three types of color light modulated by the light modulators 343R, 343G, and 343B. The image light as a result of the combination performed by the light combining system 345 enters the projection optical apparatus 36. In the present embodiment, the light combining system 345 is configured with a cross dichroic prism having a substantially rectangular-box-like shape, and may instead be configured with multiple dichroic mirrors.

The optical part enclosure 35 houses the homogenizing system 31, the color separation system 32, and the relay system 33 described above. A designed optical axis Ax is set in the image projecting apparatus 3, and the optical part enclosure 35 holds the homogenizing system 31, the color separation system 32, the relay system 33, and the light modulating apparatuses 34 at predetermined positions on the optical axis Ax. The light source apparatus 4, the light modulating apparatuses 34, and the projection optical apparatus 36 are disposed at predetermined positions on the optical axis Ax.

The projection optical apparatus 36 projects the image light incident from the light modulating apparatuses 34 onto a projection surface such as a screen. That is, the projection optical apparatus 36 projects the image light formed by the light modulating apparatuses 34. The projection optical apparatus 36 can, for example be, an assembled lens including multiple lenses and a lens barrel that houses the multiple lenses.

### Configuration of Light Source Apparatus

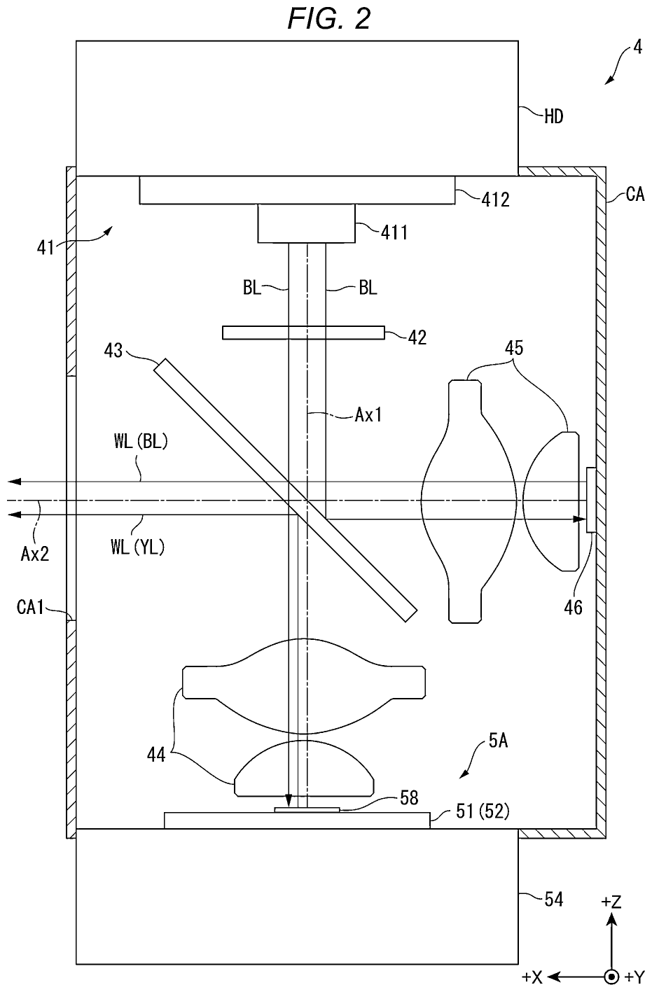

FIG. 2 is a diagrammatic view showing the configuration of the light source apparatus 4.

The light source apparatus 4 outputs illumination light WL in the +X direction toward the homogenizing system 31. The light source apparatus 4 includes a solid-state light source 41, a diffusively transmissive section 42, a light separator 43, a first light collector 44, a wavelength converting apparatus 5A, a second light collector 45, a diffusive optical member 46, and a light source enclosure CA, as shown in FIG. 2.

The following axes are set in the light source apparatus 4: an optical axis Ax1 extending along the Z-axis; and an optical axis Ax2 extending along the X-axis, and the optical axes Ax1 and Ax2 are perpendicular to each other. The optical parts of the light source apparatus 4 are disposed in the optical axis Ax1 or Ax2.

Specifically, the solid-state light source 41, the diffusively transmissive section 42, the light separator 43, the first light collector 44, and the wavelength converting apparatus 5A are disposed in the optical axis Ax1.

The diffusive optical member 46, the second light collector 45, and the light separator 43 are disposed in the optical axis Ax2. That is, the light separator 43 is disposed at the intersection of the optical axis Ax1 and the optical axis Ax2.

The optical axis Ax2 is linked to the optical axis Ax of the image projecting apparatus 3 at the lens array 311 of the homogenizing system 31.

### Configuration of Solid-State Light Source

The solid-state light source 41 outputs light in the −Z direction. The solid-state light source 41 includes a light emitter 411 and a substrate 412.

The light emitter 411 emits blue light BL. The blue light BL is excitation light that excites a phosphor of the wavelength converting apparatus 5A. The light emitter 411 is, for example, a semiconductor laser that outputs laser light having a peak wavelength of 455 nm.

The substrate 412 is fixed to the inner surface of the light source enclosure CA while supporting the light emitter 411. The substrate 412 receives heat from the light emitter 411 and transfers the received heat to a heat dissipating member HD exposed to the space outside the light source enclosure CA.

### Configuration of Diffusively Transmissive Section

The diffusively transmissive section 42 diffuses the blue light BL incident from solid-state light source 41 and outputs light having a homogenized illuminance distribution. The blue light BL output from the diffusively transmissive section 42 is incident on the light separator 43. The diffusively transmissive section 42 can, for example, have a configuration including a hologram, a configuration in which multiple lenslets are arranged in a plane perpendicular to the optical axis, or a configuration in which light passage surfaces are rough surfaces.

In place of the diffusively transmissive section 42, a homogenizer optical element including a pair of multi-lens arrays may be employed in the light source apparatus 4. When the diffusively transmissive section 42 is employed, the distance from the solid-state light source 41 to the light separator 43 can be reduced as compared with the case where the homogenizer optical element is employed.

### Configuration of Light Separator

The light separator 43 has the function of a half-silvered mirror that transmits part of the blue light BL incident thereon from the solid-state light source 41 via the diffusively transmissive section 42 and reflects the remainder of the blue light BL. That is, the light separator 43 transmits first partial light that is part of the blue light BL incident from the diffusively transmissive section 42 in the −Z direction to cause the transmitted light to enter the first light collector 44, and reflects second partial light that is the remainder of the blue light BL toward the negative end of the X direction to cause the reflected light to enter the second light collector 45.

The light separator 43 further has the function of a dichroic mirror that reflects fluorescence YL incident from the wavelength converting apparatus 5A in the +Z direction and transmits the blue light BL incident from the diffusive optical member 46 in the +X direction.

### Configuration of First Light Collector

The first light collector 44 causes the first partial light having passed through the light separator 43 to be collected at the wavelength converting apparatus 5A. The first light collector 44 parallelizes the fluorescence YL incident from the wavelength converting apparatus 5A and causes the parallelized fluorescence YL to be incident on the light separator 43 along the +Z direction.

### Schematic Configuration of the Wavelength Converting Apparatus

The wavelength converting apparatus 5A is a reflective wavelength converter that converts the wavelength of the light incident thereon, diffuses the converted light in the opposite direction of the direction of the incident light, and outputs the diffused light. The light output from the wavelength converting apparatus 5A is the fluorescence YL, which is non-polarized light and has peak wavelengths ranging, for example, from 500 to 700 nm, and the fluorescence YL contains green light and red light. The configuration of the wavelength converting apparatus 5A will be described later in detail.

The fluorescence YL output from the wavelength converting apparatus 5A passes through the first light collector 44 along the optical axis Ax1 and is incident on the light separator 43. The fluorescence YL incident on the light separator 43 is reflected off the light separator 43 in the +X direction, and exits out of the light source apparatus 4 along the optical axis Ax2.

### Configuration of Second Light Collector

The second light collector 45 causes the second partial light incident from the light separator 43 to be collected at the diffusive optical member 46. The second light collector 45 parallelizes the blue light incident from the diffusive optical member 46 and causes the parallelized blue light to be incident on the light separator 43 along the +Z direction.

### Configuration of Diffusive Optical Member

The diffusive optical member 46 reflects and diffuses the blue light BL incident from the second light collector 45 at a diffusion angle substantially equal to the diffusion angle of the fluorescence YL output from the wavelength converting apparatus 5A or a diffusion angle slightly smaller than the diffusion angle of the fluorescence YL. That is, the diffusive optical member 46 diffuses and reflects the light incident thereon without converting the wavelength of the incident light.

The blue light BL reflected off the diffusive optical member 46 in the X +direction passes through the second light collector 45, then passes through the light separator 43 in the +X direction, and exits out of the light source apparatus 4 along with the fluorescence YL.

As described above, the illumination light WL that exits out of the light source apparatus 4 is white light that is the mixture of the blue light BL and the fluorescence YL containing green light and red light. The illumination light WL is output from the light source apparatus 4 in the +X direction via a passage port CA1 of the light source enclosure CA.

### Configuration of Light Source Enclosure

The light source enclosure CA is an enclosure of the light source apparatus 4, and is one of internal enclosures housed inside the exterior enclosure 2. The light source enclosure CA houses the solid-state light source 41, the diffusively transmissive section 42, the light separator 43, the first light collector 44, the wavelength converting apparatus 5A, the second light collector 45, and the diffusive optical member 46. In the present embodiment, the light source enclosure CA is a sealed enclosure that dirt and dust is unlikely to enter, but not necessarily. The light source enclosure CA only needs to house the optical parts described above.

The light source enclosure CA has the passage port CA1. The passage port CAI is an opening via which the illumination light WL exits out of the light source enclosure CA.

### Detailed Configuration of Wavelength Converting Apparatus

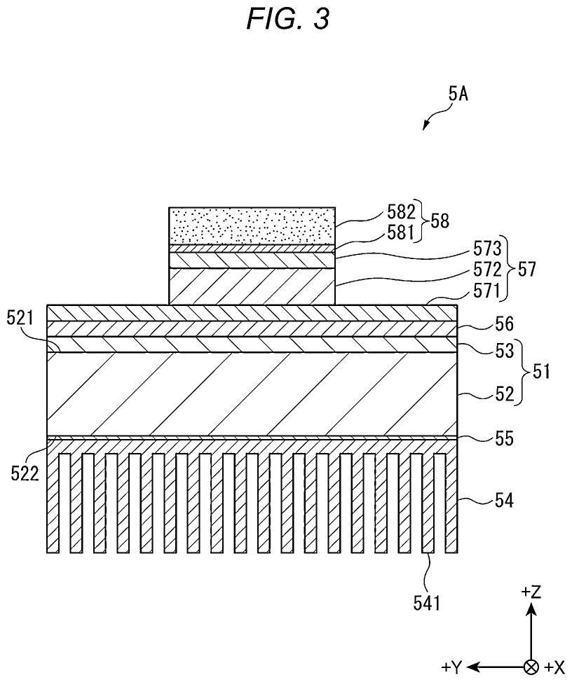

FIG. 3 shows the cross-section of the wavelength converting apparatus 5A taken along the XZ plane. That is, FIG. 3 shows the cross section of the wavelength converting apparatus 5A taken along the plane specified by the −Z direction, which is the direction in which the blue light BL is incident on the wavelength converting apparatus 5A, and the +X direction perpendicular to the −Z direction.

The wavelength converting apparatus 5A outputs in the +Z direction the fluorescence YL, which is the converted light having a wavelength band having wavelengths longer than those in the wavelength band of the blue light BL incident along the −Z direction, as described above. The wavelength converting apparatus 5A includes a substrate 51, a heat dissipating member 54, grease 55, a joining reinforcing layer 56, a joining layer 57, and a wavelength converter 58, as shown in FIG. 3. In the wavelength converting apparatus 5A, the wavelength converter 58, the joining layer 57, the joining reinforcing layer 56, the substrate 51, the grease 55, and the heat dissipating member 54 are arranged in this order in the −Z direction, which is the direction in which the blue light BL is incident.

### Configuration of Substrate

The substrate 51 is made of either copper or a copper alloy. The substrate 51 supports the wavelength converter 58 jointed via the joining reinforcing layer 56 and the joining layer 57. The substrate 51 includes a base 52 and a copper oxide layer 53.

The base 52 is a plate-shaped body made of either copper or a copper alloy. The base 52 supports the wavelength converter 58, and transfers heat transferred from the wavelength converter 58 to the heat dissipating member 54 via the grease 55. The base 52 has a first surface 521 and a second surface 522.

The first surface 521 is a surface of the base 52 that faces the positive end of the Z direction. The copper oxide layer 53 is formed at the first surface 521.

The second surface 522 is the surface of the base 52 that is opposite from the first surface 521. The second surface 522 faces the heat dissipating member 54 via the grease 55. The base 52 may contain copper and a copper alloy at a predetermined proportion or higher. For example, at least 90% of the composition of the base 52 may be copper or a copper alloy. The base 52 may contain impurities.

The copper oxide layer 53 is configured with a copper oxide film formed at least at the first surface 521 of the base 52. The copper oxide layer 53 may be a natural oxide film naturally formed at the base 52, or may be an oxide film formed at the base 52 by a predetermined treatment. The predetermined treatment may, for example, be a treatment of heating the base 52 to 200° C. in a constant temperature chamber. The heat treatment may be performed after degreasing the base 52 with alcohol, immersing the base 52 in a soft etching liquid for a predetermined period, and drying the base 52 with a dryer.

The copper oxide layer 53 may be omitted.

### Configurations of Heat Dissipating Member and Grease

The heat dissipating member 54 dissipates the heat of the wavelength converter 58 transferred from the base 52. The heat dissipating member 54 can be configured, for example, with a heat sink having multiple fins 541.

The grease 55 is thermally conductive grease provided between the second surface 522 of the base 52 and the heat dissipating member 54. The grease 55 transfers the heat transferred via the second surface 522 to the heat dissipating member 54.

When a copper substrate made of copper or a copper alloy is pressed, rolled, or otherwise processed, the copper substrate warps. That is, the base 52 warps in some cases. In such a case, a decrease in the strength of the joining between the base 52 and the wavelength converter 58 can be suppressed by fixing the heat dissipating member 54 to the base 52 via the grease 55 with the convex side of the warpage of the base 52 facing the heat dissipating member 54.

### Configuration of Joining Reinforcing Layer

The joining reinforcing layer 56 is a tin oxide layer layered at the copper oxide layer 53. The joining reinforcing layer 56 has the function of increasing the strength of the joining and the strength of the adhesion between the base 52 and the joining layer 57, and hence increasing the strength of the joining between the base 52 and the wavelength converter 58. The composition and thickness of the joining reinforcing layer 56 will be described later in detail.

### Configuration of Joining Layer

The joining layer 57 joins, along with the joining reinforcing layer 56, the base 52 and the wavelength converter 58 to each other. The joining layer 57 includes a first joining layer 571, a second joining layer 572, and a third joining layer 573.

The first joining layer 571 is layered at the joining reinforcing layer 56. The first joining layer 571 contains noble metal out of silver (Ag), gold (Au), platinum (Pt), and palladium (Pd). In the present embodiment, the first joining layer 571 is a joining layer containing silver particles.

The second joining layer 572 is layered at the first joining layer 571. The second joining layer 572 is a joining layer containing metal nanoparticles, specifically, a joining layer containing noble metal nanoparticles. In the present embodiment, the second joining layer 572 is made of silver nano-paste containing silver nanoparticles.

The third joining layer 573 is layered at the second joining layer 572. The third joining layer 573 contains noble metal out of silver, gold, platinum, and palladium. In the present embodiment, the third joining layer 573 contains silver particles, which are readily joined to the silver nanoparticles contained in the second joining layer 572 during sintering, as the first joining layer 571. That is, the first joining layer 571 and the third joining layer 573 are auxiliary joining layers that assist the second joining layer 572, which is the primary joining layer.

Sintering the thus configured joining layer 57 at, for example, 200° C. causes the silver particles in the first joining layer 571 and the third joining layer 573 and the silver nanoparticles in the second joining layer 572 to be diffusively joined to each other through thermocompression joining. The base 52 and the wavelength converter 58 are thus joined to each other.

### Configuration of Wavelength Converter

The wavelength converting apparatus 5A is provided with the wavelength converter 58 at the end which faces the positive end of the Z direction and on which the blue light BL is incident. The wavelength converter 58 includes a reflection layer 581 and a phosphor layer 582.

The reflection layer 581 is layered at the third joining layer 573. That is, the reflection layer 581 is disposed in the wavelength converter 58 at the side facing the base 52. The reflection layer 581 reflects the light incident from the phosphor layer 582 toward the phosphor layer 582. The reflection layer 581 can be configured with a multilayer film including a total reflection film.

The phosphor layer 582 is layered at the reflection layer 581 at the side opposite from the base 52. That is, the phosphor layer 582 is layered at the reflection layer 581 at the side on which the blue light BL is incident. The phosphor layer 582 contains a phosphor excited by the blue light BL incident thereon. The phosphor may, for example, be a YAG:Ce phosphor containing cerium as an activator. The blue light BL directly enters the phosphor layer 582 from the first light collector 44, and the phosphor layer 582 outputs the fluorescence YL in response to the incidence of the blue light BL.

### Composition of Joining Reinforcing Layer

To select the material of the joining reinforcing layer 56, the persons disclosing the present application formed the joining reinforcing layer 56 containing tin oxide and the joining reinforcing layer 56 containing nickel, and measured the tensile strength achieved when each of the joining reinforcing layers 56 is employed. The tensile strength is expressed in N.

To measure the tensile strength, the following two samples were prepared: a target sample in which the joining reinforcing layer 56 that was a tin oxide layer and the joining layer 57 were formed at the base 52; and a comparative sample in which the joining reinforcing layer 56 that was a nickel layer and the joining layer 57 were formed at the base 52. Thereafter, the base 52 of each of the samples was fixed, a fixture was glued to the joining layer 57 of each of the samples with an adhesive with the glued area being 3 millimeters square, and the fixture was then pulled in the direction away from the base 52 to measure the tensile strength of each of the samples.

The comparative sample after vapor deposition of the nickel layer provided a tensile strength of 248 N. In contrast, the target sample after vapor deposition of the tin oxide layer provided a tensile strength of 560 N.

The persons disclosing the present application then measured the tensile strength of each of the samples after performing a thermal shock test in which cooling the sample to −20° C. and heating the sample to 100° C. were alternately repeated 500 times.

The comparative sample after the thermal shock test provided a tensile strength of 104 N. In contrast, the target sample after the thermal shock test provided a tensile strength of 458 N.

It has therefore been found that the joining reinforcing layer 56 is more preferably a tin oxide layer than a nickel layer.

### Composition of Tin Oxide in Joining Reinforcing Layer

The persons disclosing the present application studied the composition of the tin oxide contained in the joining reinforcing layer 56 in order to increase the strength of the joining between the base 52 and the joining layer 57 via the joining reinforcing layer 56. That is, the persons disclosing the present application measured the strength of the joining between the base 52 and the joining layer 57 for a variety of molar composition ratios of the tin oxide, and studied a suitable molar composition ratio of the tin oxide in the joining reinforcing layer 56. The method for measuring the tensile strength measured as the joining strength is the same as the aforementioned measurement method using the fixture.

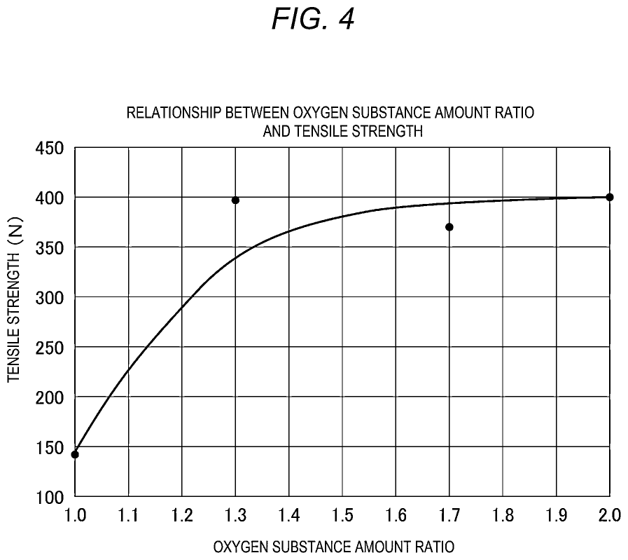

FIG. 4 is a graph showing the relationship between the ratio of the amount of substance of oxygen to the amount of substance of tin in the joining reinforcing layer 56 and the tensile strength of the joining layer 57.

Assuming that an oxygen substance amount ratio was the ratio of the amount of substance of oxygen to the amount of substance of tin in the joining reinforcing layer 56, and when the oxygen substance amount ratio was 1, that is, when substantially all the tin oxide contained in the joining reinforcing layer 56 was tin monoxide, the tensile strength described above was 142 N, as shown in FIG. 4. Tin monoxide has a tetragonal crystal structure.

When the oxygen substance amount ratio was 1.3, the tensile strength described above was 397 N, and when the oxygen substance amount ratio was 1.7, the tensile strength described above was 370 N. That is, it has been found that the tensile strength described above in the case where the tin oxide that constitutes the joining reinforcing layer 56 is tin monoxide and tin dioxide is greater than the tensile strength described above in the case where substantially all the tin oxide that constitutes the joining reinforcing layer 56 is tin monoxide. Tin dioxide has a rutile-type crystal structure.

When the ratio of the amount of substance of oxygen to the amount of substance of tin in the joining reinforcing layer 56 was 2, the tensile strength described above was 400 N. That is, it has been found that the tensile strength is maximized when substantially all the tin oxide contained in the joining reinforcing layer 56 is tin dioxide.

From the results of the measurement of the tensile strength, when the aforementioned tensile strength required when the joining reinforcing layer 56 containing tin oxide is provided in the wavelength converting apparatus 5A is set at 300 N or greater, the oxygen substance amount ratio is 1.3 or greater, so that the base 52 and the joining layer 57 can be firmly joined to each other, and the wavelength converter 58 can be firmly joined to the base 52 via the joining reinforcing layer 56 and the joining layer 57.

### Change in Tensile Strength With Thickness of Joining Reinforcing Layer

In general, when a thin film is formed at a film formation target by a sputtering apparatus or a vapor deposition apparatus, island-shaped thin films are first formed at the surface of the film formation target, and then the island-shaped thin films are joined to each other to grow into a continuous film. In contrast, the persons disclosing the present application have found that when the joining reinforcing layer 56 that is a tin oxide layer is island-shaped layers, noble metal such as silver contained in the joining layer 57 comes into direct contact with the copper oxide layer 53, resulting in unsatisfactory adhesion between the joining reinforcing layer 56 and the joining layer 57. That is, the persons disclosing the present application have found that, to ensure the adhesion between the joining reinforcing layer 56 and the joining layer 57, the joining reinforcing layer 56 and the joining layer 57 need to be completely in contact with each other in the regions where the two layers face with each other.

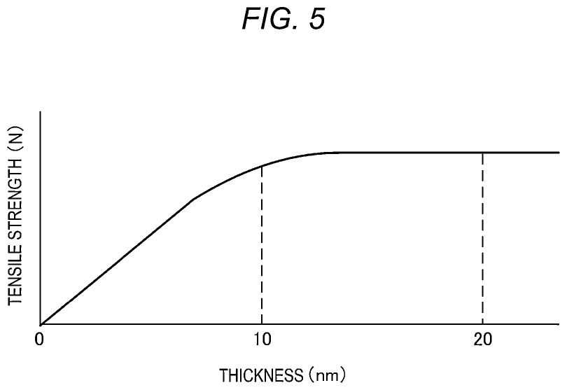

FIG. 5 is a graph showing the relationship between the thickness of the joining reinforcing layer 56 and the tensile strength of the portion between the joining reinforcing layer 56 and the joining layer 57. The thickness of the joining reinforcing layer 56 is a dimension along the direction in which the blue light BL is incident on the wavelength converting apparatus 5A, that is, a dimension along the −Z direction. The same holds true for the other layers.

Based on the findings described above, the persons disclosing the present application measured the tensile strength of the portion between the joining reinforcing layer 56 and the joining layer 57 for a variety of thicknesses of the joining reinforcing layer 56. The method for measuring the tensile strength is the same as the aforementioned measurement method using the fixture.

FIG. 5 showing the relationship between the thickness of the joining reinforcing layer 56 and the tensile strength described above indicates that sufficient tensile strength can be ensured when the thickness of the joining reinforcing layer 56 reaches 10 nm. In other words, when the thickness of the joining reinforcing layer 56 reaches 10 nm, it is estimated that the tin oxide film becomes a continuous film, and that the joining reinforcing layer 56 and the joining layer 57 are in complete contact with each other in the region where the two layers face with each other.

It is further found that a thickness of the joining reinforcing layer 56 greater than or equal to 20 nm can ensure sufficient tensile strength and sufficient adhesion even when variations occur in the film formation step or other steps.

Therefore, in terms of adhesion between the joining reinforcing layer 56 and the joining layer 57, the thickness of the joining reinforcing layer 56 is preferably 10 nm or greater, more preferably 20 nm or greater.

### Suppression of Diffusion of Copper Atoms by Using Joining Reinforcing Layer

Although not shown in detail, the persons disclosing the present application have found as a result of analysis of the components of the joining layer layered at the copper substrate and sintered that the copper atoms move from the base 52 and the copper oxide layer 53 to the surface of the first joining layer 571 in the joining layer 57. In detail, when the layers are each formed by vapor deposition, the silver films are configured with multiple crystals, in which case, it has been found that the copper atoms readily diffuse via the crystal interface of each of the silver films into the silver film and precipitate at the surface of the silver film.

A sintered joining material such as the second joining layer 572 is configured with silver nanoparticles and a protective agent, and when the protective agent is heated and thus volatilizes, the silver nanoparticles in the second joining layer 572 and the silver particles in the first joining layer 571 and the third joining layer 573 diffuse into each other and form a metal bond. Since copper atoms present on any of the silver films inhibit the metal bond between the silver nanoparticles and the silver particles, the joining between the base 52 and the joining layer 57 is inhibited, which is believed to be a cause of lowering the strength of the joining between the base 52 and the wavelength converter 58.

The findings described above have caused the persons disclosing the present application to consider that it is necessary to suppress the diffusion of the copper atoms into the joining layer 57 by providing a protective layer between the substrate 51, which includes the base 52 and the copper oxide layer 53, and the joining layer 57.

In this respect, in the wavelength converting apparatus 5A, the joining reinforcing layer 56 containing tin oxide is interposed as a copper atom diffusion suppressing layer between the copper oxide layer 53 formed at the base 52 and the joining layer 57 containing silver particles and silver nanoparticles, as described above. It has been found that the thus configured joining reinforcing layer 56 can suppress the diffusion of the copper atoms into the joining layer 57.

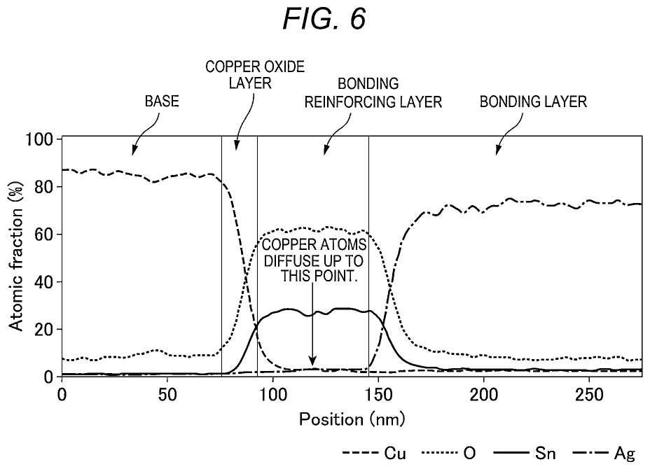

FIG. 6 shows a result of the analysis of the components of the base 52, the copper oxide layer 53, the joining reinforcing layer 56, and the joining layer 57 of the wavelength converting apparatus 5A with the component analysis performed in the +Z direction.

In detail, FIG. 6 showing the result of the component analysis indicates that the copper atoms from the base 52 and the copper oxide layer 53 diffuse into the region next to the copper oxide layer 53 and having a thickness of 25 nm in the joining reinforcing layer 56 containing tin oxide and having a thickness of 50 nm. In other words, it has been found that the copper atoms from the base 52 and the copper oxide layer 53 are unlikely to diffuse beyond the position separate by 25 nm from the surface of the joining reinforcing layer 56 that faces the base 52 toward the joining layer 57 located at the side opposite from the base 52 with respect to the joining reinforcing layer 56.

Setting the thickness of the joining reinforcing layer 56 disposed between the base 52 and the joining layer 57 at a value greater than or equal to 25 nm, preferably greater than or equal to 30 nm can therefore prevent the copper atoms from diffusing into the joining layer 57. That is, in terms of suppression of the diffusion of the copper atoms into the joining layer 57 by using the joining reinforcing layer 56, the thickness of the joining reinforcing layer 56 is preferably 25 nm or greater, more preferably 30 nm or greater.

The configuration described above can increase the strength of the joining between the base 52 and the joining layer 57, and hence the strength of the joining of the wavelength converter 58 to the base 52. In this case, the joining reinforcing layer 56 functions as a diffusion suppressing layer that suppresses the diffusion of the copper atoms.

### Effects of the First Embodiment

The projector 1 according to the present embodiment described above provides the effects below.

The projector 1 includes the light source apparatus 4, the image light generating apparatus 30, and the projection optical apparatus 36. The image light generating apparatus 30 generates image light from the light from the light source apparatus 4, and the projection optical apparatus 36 projects the generated image light.

The light source apparatus 4 includes the solid-state light source 41, which outputs excitation light, and the wavelength converting apparatus 5A, which converts the wavelength of the excitation light.

The wavelength converting apparatus 5A includes the base 52, the copper oxide layer 53, the joining reinforcing layer 56, the joining layer 57, and the wavelength converter 58.

The base 52 is made of either copper or a copper alloy.

The copper oxide layer 53 is formed at the first surface 521 of the base 52.

The joining reinforcing layer 56 is a tin oxide layer containing tin oxide and layered at the copper oxide layer 53.

The joining layer 57 is disposed at the joining reinforcing layer 56.

The wavelength converter 58 is disposed at the joining layer 57.

The configuration described above, in which the copper oxide layer 53 is formed at the first surface 521, can suppress deterioration of the base 52 made of copper or a copper alloy.

Furthermore, the configuration in which the joining reinforcing layer 56, which is a tin oxide layer, is layered at the copper oxide layer 53 can enhance the adhesion between the joining reinforcing layer 56 and the joining layer 57, and hence the adhesion between the base 52 and the joining layer 57. In addition, the joining reinforcing layer 56, which functions as the diffusion suppressing layer, can suppress movement of the copper atoms from the base 52 and the copper oxide layer 53 to the joining layer 57.

The strength of the joining between the wavelength converter 58 and the base 52 via the joining layer 57 can therefore be increased, so that a stable wavelength converting apparatus 5A can be configured. Accordingly, a light source apparatus 4 capable of stably outputting light can be configured, and a projector 1 capable of stably projecting image light can be further configured.

In the wavelength converting apparatus 5A, the wavelength converter 58 includes the reflection layer 581 and the phosphor layer 582. The reflection layer 581 is disposed in the wavelength converter 58 at the side facing the base 52, and the phosphor layer 582 is layered at the reflection layer 581. In detail, the phosphor layer 582 is a layer containing a phosphor excited by the light incident thereon, and is layered at the reflection layer 581 at the side opposite from the base 52.

According to the configuration described above, the wavelength converting apparatus 5A can be configured as a stable reflective wavelength converting apparatus.

In the wavelength converting apparatus 5A, the joining layer 57 includes the first joining layer 571 layered at the joining reinforcing layer 56 and containing any one of silver, gold, platinum, and palladium. In the present embodiment, the first joining layer 571 contains silver.

Since the tin oxide layer that constitutes the joining reinforcing layer 56 intimately adheres also to the joining layer 57 including the first joining layer 571 described above, the strength of the joining between the wavelength converter 58 and the base 52 via the joining layer 57, can be increased. A stable wavelength converting apparatus 5A can therefore be configured.

In the wavelength converting apparatus 5A, the joining layer 57 includes, in addition to the first joining layer 571, the second joining layer 572 layered at the first joining layer 571 and containing silver nanoparticles, and the third joining layer 573 layered at the second joining layer 572 and containing any one of silver, gold, platinum, and palladium. In the present embodiment, the third joining layer 573 contains silver, as the first joining layer 571.

The configuration described above, in which the joining layer 57 includes the second joining layer 572 and the third joining layer 573 as well as the first joining layer 571, can increase the strength of the joining between the wavelength converter 58 and the base 52 via the joining layer 57. A stable wavelength converting apparatus 5A can therefore be configured.

In the wavelength converting apparatus 5A, the joining reinforcing layer 56 has a thickness of 10 nm or greater.

The configuration described above, in which the joining reinforcing layer 56 containing tin oxide can be formed as a continuous layer, can increase the strength of the joining between the joining reinforcing layer 56 and the joining layer 57. A stable wavelength converting apparatus 5A can therefore be configured.

In the wavelength converting apparatus 5A, the joining reinforcing layer 56 has a thickness of 20 nm or greater.

The configuration described above, in which the strength of the joining between the joining reinforcing layer 56 and the joining layer 57 can be further increased, can stably join the wavelength converter 58 to the base 52. A stable wavelength converting apparatus 5A can therefore be configured.

In the wavelength converting apparatus 5A, when the amount of substance of tin is 1 in the molar composition ratio of the tin oxide film that constitutes the joining reinforcing layer 56, the amount of substance of oxygen is greater than or equal to 1.3 but smaller than or equal to 2.0.

The configuration described above, which can increase the strength of the adhesion between the joining reinforcing layer 56, which is a tin oxide layer, and the joining layer 57, can stably join the wavelength converter 58 to the base 52. A stable wavelength converting apparatus 5A can therefore be configured.

### Second Embodiment

A second embodiment of the present disclosure will next be described. The wavelength converting apparatus according to the present embodiment has the same configuration as that of the wavelength converting apparatus 5A according to the first embodiment, but differs therefrom in that a diffusion suppressing layer 59 is provided in place of the joining reinforcing layer 56 of the wavelength converting apparatus 5A. In the following description, portions that are the same or substantially the same as the portions having been already described have the same reference characters and will not be described.

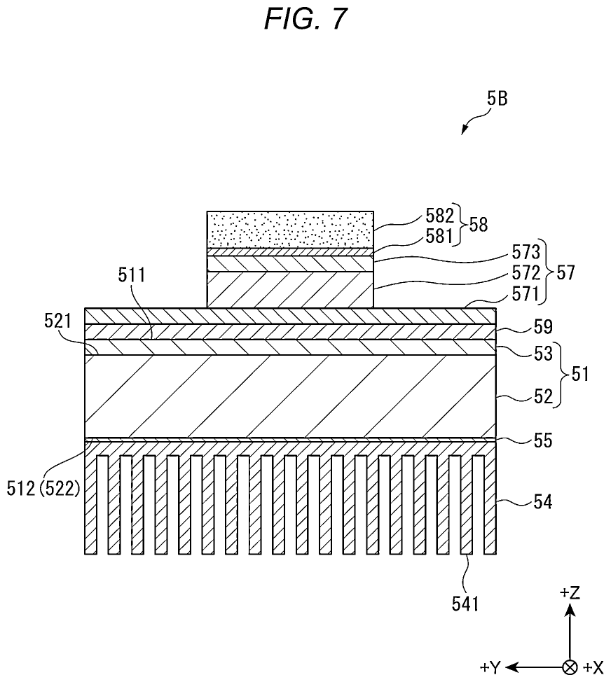

The light source apparatus according to the present embodiment has the same configuration and function as those of the light source apparatus 4 according to the first embodiment except that a wavelength converting apparatus 5B shown in FIG. 7 is provided in place of the wavelength converting apparatus 5A. The wavelength converting apparatus 5B has the same configuration and function as those of the wavelength converting apparatus 5A according to the first embodiment except that the wavelength converting apparatus 5B includes the diffusion suppressing layer 59 in place of the joining reinforcing layer 56.

### Detailed Configuration of Wavelength Converting Apparatus

FIG. 7 shows the cross-section of the wavelength converting apparatus 5B taken along the XZ plane. That is, FIG. 7 shows the cross section of the wavelength converting apparatus 5B taken along the plane specified by the −Z direction, which is the direction in which the blue light BL is incident on the wavelength converting apparatus 5B, and the +X direction perpendicular to the −Z direction.

The wavelength converting apparatus 5B outputs, in the +Z direction, the fluorescence YL, which is the converted light having a wavelength band longer than the wavelength band of the blue light BL incident along the −Z direction, as described above. The wavelength converting apparatus 5B includes the substrate 51, the heat dissipating member 54, the grease 55, the diffusion suppressing layer 59, the joining layer 57, and the wavelength converter 58, as shown in FIG. 7. In the wavelength converting apparatus 5B, the wavelength converter 58, the joining layer 57, the diffusion suppressing layer 59, the substrate 51, the grease 55, and the heat dissipating member 54 are arranged in this order in the −Z direction, which is the direction in which the blue light BL is incident.

### Configuration of Substrate

The substrate 51 is made of either copper or a copper alloy. The substrate 51 supports the wavelength converter 58 joined via the diffusion suppressing layer 59 and the joining layer 57. The substrate 51 has a first surface 511 and a second surface 512. The first surface 511 is a surface of the substrate 51 that faces the positive end of the Z direction, and the second surface 512 is a surface opposite from the first surface 511.

In addition, the substrate 51 includes the base 52 and the copper oxide layer 53. The second surface 522 is a surface of the base 52 that is opposite from the first surface 521, and constitutes the second surface 512. The copper oxide layer 53 constitutes the first surface 511.

### Configuration of Diffusion Suppressing Layer

The diffusion suppressing layer 59 is a tin oxide layer layered at the copper oxide layer 53. That is, the diffusion suppressing layer 59 is layered at the first surface 511. The diffusion suppressing layer 59 has the function of suppressing the diffusion of the copper atoms from the substrate 51 into the joining layer 57. In the thus configured wavelength converting apparatus 5B, the adhesion between the diffusion suppressing layer 59 and the joining layer 57 is increased, and hence the strength of the joining between the base 52 and the wavelength converter 58 is increased. The thickness and composition of the diffusion suppressing layer 59 will be described later in detail.

### Configuration of Joining Layer

The joining layer 57 joins the diffusion suppressing layer 59 and the wavelength converter 58 to each other, and hence joins the substrate 51 and the wavelength converter 58 to each other. The joining layer 57 includes a first joining layer 571, a second joining layer 572, and a third joining layer 573.

The first joining layer 571 is layered at the diffusion suppressing layer 59. Sintering the joining layer 57 at, for example, 200° C. causes the silver particles in the first joining layer 571 and the third joining layer 573 and the silver nanoparticles in the second joining layer 572 to be diffusively joined to each other through thermocompression joining. The diffusion suppressing layer 59 formed at the substrate 51 and the wavelength converter 58 are thus joined to each other, and hence the substrate 51 and the wavelength converter 58 are joined to each other.

### Suppression of Diffusion of Copper Atoms by Using Diffusion Suppressing Layer

Although not shown in detail, the persons disclosing the present application have found as a result of analysis of the components of the joining layer layered at the copper substrate and sintered that the copper atoms move from the base 52 and the copper oxide layer 53 to the surface of the first joining layer 571 in the joining layer 57. In detail, when the layers are each formed by vapor deposition, the silver films are configured with multiple crystals, in which case, it has been found that the copper atoms readily diffuse via the crystal interface of each of the silver films into the silver film and precipitate at the surface of the silver film.

A sintered joining material such as the second joining layer 572 is configured with silver nanoparticles and a protective agent, and when the protective agent is heated and thus volatilizes, the silver nanoparticles in the second joining layer 572 and the silver particles in the first joining layer 571 and the third joining layer 573 diffuse into each other and form a metal bond. Since copper atoms present on any of the silver films inhibit the metal bond between the silver nanoparticles and the silver particles, the joining between the substrate 51 and the joining layer 57 is inhibited, which is believed to be a cause of lowering the strength of the joining between the substrate 51 and the wavelength converter 58.

The findings described above have caused the persons disclosing the present application to consider that it is necessary to suppress the diffusion of the copper atoms into the joining layer 57 by providing a protective layer between the substrate 51, which includes the base 52 and the copper oxide layer 53, and the joining layer 57.

In this respect, in the wavelength converting apparatus 5B, the diffusion suppressing layer 59 containing tin oxide is interposed as the copper atom diffusion suppressing layer between the copper oxide layer 53 formed at the base 52 and the joining layer 57 containing silver particles and silver nanoparticles, as described above. It has been found that the thus configured diffusion suppressing layer 59 can suppress the diffusion of the copper atoms into the joining layer 57.

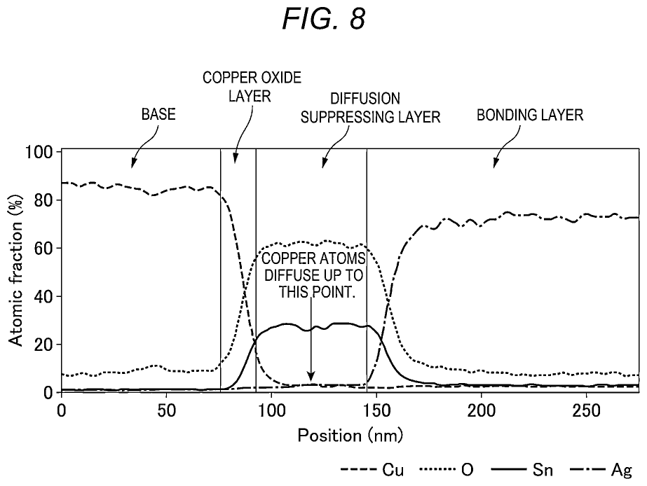

FIG. 8 shows a result of the analysis of the components of the base 52, the copper oxide layer 53, the diffusion suppressing layer 59, and the joining layer 57 of the wavelength converting apparatus 5B with the component analysis performed in the +Z direction.

In detail, FIG. 8 showing the result of the component analysis indicates that the copper atoms from the base 52 and the copper oxide layer 53 diffuse into the region next to the copper oxide layer 53 and having a thickness of 25 nm in the diffusion suppressing layer 59 containing tin oxide and having the thickness of 50 nm. In other words, it has been found that the copper atoms from the base 52 and the copper oxide layer 53 are unlikely to diffuse beyond the position separate by 25 nm from the surface of the diffusion suppressing layer 59 that faces the base 52 toward the joining layer 57 located at the side opposite from the base 52 with respect to the diffusion suppressing layer 59.

Therefore, when the thickness of the diffusion suppressing layer 59 is defined as the dimension along the −Z direction, which is the direction in which the blue light BL is incident on the wavelength converting apparatus 5B, setting the thickness of the diffusion suppressing layer 59 disposed between the base 52 and the joining layer 57 at a value greater than or equal to 25 nm, preferably greater than or equal to 30 nm can prevent the diffusion of the copper atoms into the joining layer 57. That is, in terms of suppression of the diffusion of the copper atoms into the joining layer 57 by using the diffusion suppressing layer 59, the thickness of the diffusion suppressing layer 59 is preferably 25 nm or greater, more preferably 30 nm or greater.

The configuration described above can increase the strength of the joining between the substrate 51 and the joining layer 57, and hence the strength of the joining of the wavelength converter 58 to the substrate 51.

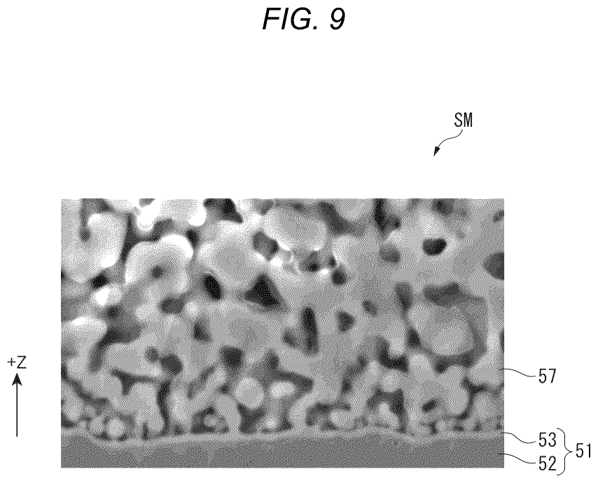

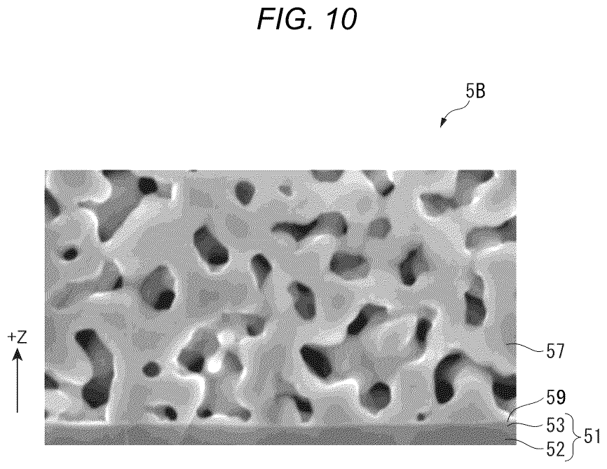

FIG. 9 shows an image captured under a scanning electron microscope (SEM) and showing a part of a cross section of a sample SM, and FIG. 10 shows an SEM image of a part of a cross section of the wavelength converting apparatus 5B.

The person disclosing the present application compared the SEM image showing a part of a cross section of the sample SM with the SEM image showing a part of a cross section of the wavelength converting apparatus 5B. The sample SM has the same configuration as that of the wavelength converting apparatus 5B except that the diffusion suppressing layer 59 is not provided.

Since the diffusion suppressing layer 59 is not present in the sample SM, it is believed that the copper atoms from the substrate 51 have diffused to the surface of the joining layer 57 that faces the substrate 51, as shown in FIG. 9. It is therefore found that the silver nanoparticles cannot be diffused to the surface of the joining layer 57 that faces the substrate 51 in the sample SM, and the joining layer 57 cannot sufficiently adhere to the substrate 51.

In contrast, it is believed in the wavelength converting apparatus 5B that the diffusion of the copper atoms to the joining layer 57 is suppressed by the diffusion suppressing layer 59, as shown in FIG. 10. Since the silver nanoparticles can therefore diffuse to the surface of the joining layer 57 that faces the substrate 51, it is found that the joining layer 57 can sufficiently adhere to the diffusion suppressing layer 59 formed at the substrate 51. The configuration described above increases the strength of the joining between the substrate 51 and the wavelength converter 58 provided in the joining layer 57.

### Composition of Tin Oxide in Diffusion Suppressing Layer

The persons disclosing the present application studied the composition of the tin oxide contained in the diffusion suppression layer 59 to suppress the diffusion of the copper atoms by using the diffusion suppression layer 59. That is, the persons disclosing the present application measured the strength of the joining between the base 52 and the joining layer 57 for a variety of molar composition ratios of the tin oxide, and studied a suitable molar composition ratio of the tin oxide in the diffusion suppression layer 59.

To measure the tensile strength, the persons disclosing the present application formed a sample in which the diffusion suppressing layer 59 and the joining layer 57 were formed at the substrate 51, fixed the substrate 51, glued a fixture to the joining layer 57 with an adhesive with the glued area being 3 millimeters square, and then pulled the fixture in the direction away from the substrate 51 to measure the tensile strength of the sample.

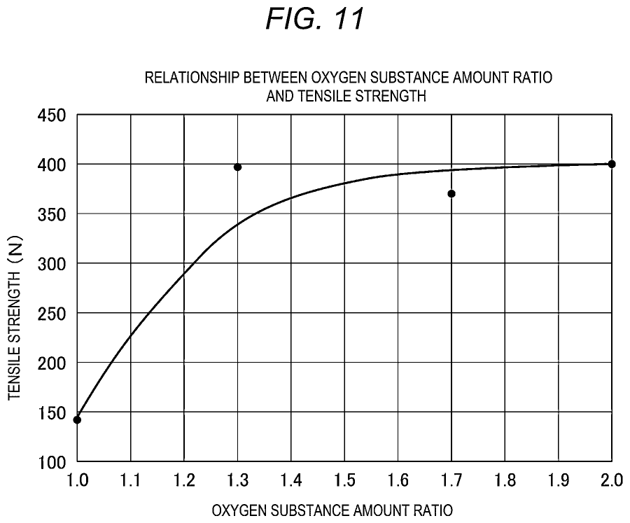

FIG. 11 is a graph showing the relationship between the ratio of the amount of substance of oxygen to the amount of substance of tin in the diffusion suppressing layer 59 and the tensile strength of the joining layer 57.

Assuming that an oxygen substance amount ratio was the ratio of the amount of substance of oxygen to the amount of substance of tin in the diffusion suppressing layer 59, and when the oxygen substance amount ratio was 1.0, that is, when substantially all the tin oxide contained in the diffusion suppressing layer 59 was tin monoxide, the tensile strength described above was 142 N, as shown in FIG. 11. Tin monoxide has a tetragonal crystal structure.

When the oxygen substance amount ratio was 1.3, the tensile strength described above was 397 N, and when the oxygen substance amount ratio was 1.7, the tensile strength described above was 370 N. That is, it has been found that the tensile strength described above in the case where the tin oxide that constitutes the diffusion suppressing layer 59 is tin monoxide and tin dioxide is greater than the tensile strength described above in the case where substantially all the tin oxide that constitutes the diffusion suppressing layer 59 is tin monoxide. Tin dioxide has a rutile-type crystal structure.

When the ratio of the amount of substance of oxygen to the amount of substance of tin in the diffusion suppressing layer 59 was 2, the tensile strength described above was 400 N. That is, it has been found that the tensile strength is maximized when substantially all the tin oxide contained in the diffusion suppressing layer 59 is tin dioxide.

From the results of the measurement of the tensile strength, when tin dioxide is contained in the diffusion suppressing layer 59, which is a tin oxide layer, it is believed that the diffusion of the copper atoms from the substrate 51 into the joining layer 57 can be effectively suppressed, and it is found that the degree of adhesion between the diffusion suppressing layer 59 and the joining layer 57 can be further enhanced as compared with a case where the tin oxide contained in the diffusion suppressing layer 59 is only tin monoxide. For example, when the oxygen substance amount ratio is greater than or equal to 1.1 but smaller than or equal to 2.0, it is believed that the diffusion suppressing layer 59 can effectively suppress the copper atoms diffused from the substrate 51.

Specifically, when the aforementioned tensile strength required in the case where the diffusion suppressing layer 59 containing tin oxide is provided in the wavelength converting apparatus 5B is set at 200 N or greater, the oxygen substance amount ratio is greater than or equal to 1.1 but smaller than or equal to 2.0, so that the diffusion suppressing layer 59 formed at the base 52 can be firmly joined to the joining layer 57, and hence the wavelength converter 58 can be firmly joined to the base 52.

In addition, when the required tensile strength described above is set at 300 N or greater, the oxygen substance amount ratio is greater than or equal to 1.3 but smaller than or equal to 2.0, so that the diffusion suppressing layer 59 and the joining layer 57 can be firmly joined to each other, and hence the wavelength converter 58 can be firmly joined to the substrate 51.

### Effects of the Second Embodiment

The projector 1 according to the present embodiment described above provides the effects below.

The projector includes the light source apparatus 4, the image light generating apparatus 30, and the projection optical apparatus 36.

The image light generating apparatus 30 generates image light from the light from the light source apparatus 4, and the projection optical apparatus 36 projects the generated image light.

The light source e apparatus 4 includes the solid-state light source 41, which outputs the blue light BL, which is the excitation light, and the wavelength converting apparatus 5B, which converts the wavelength of the blue light BL output from the solid-state light source 41.

The wavelength converting apparatus 5B includes the substrate 51, the diffusion suppressing layer 59, the joining layer 57, and the wavelength converter 58.

The substrate 51 is made of either copper or a copper alloy. The substrate 51 has the first surface 511.

The diffusion suppressing layer 59 contains tin oxide and is disposed at the first surface 511.

The joining layer 57 is disposed at the diffusion suppressing layer 59.

The wavelength converter 58 is disposed at the joining layer 57.

According to the configuration described above, in the process of joining the wavelength converter 58 to the substrate 51 via the joining layer 57, the diffusion of the copper atoms from the substrate 51 into the joining layer 57 can be suppressed by the diffusion suppressing layer 59 containing tin oxide. The configuration described above can suppress a decrease in the joining force of the joining layer 57 caused by diffusion of copper atoms into the joining layer 57. The joining layer 57 can therefore join the wavelength converter 58 and the substrate 51 to each other with increased joining strength, so that a stable wavelength converting apparatus 5B can be configured. The life of the light source apparatus 4 can thus be extended. In addition, the projector 1 can stably project the image light, and the life of the projector 1 can be extended.

In the wavelength converting apparatus 5B, the wavelength converter 58 includes the reflection layer 581 disposed in the wavelength converter 58 at the side facing the substrate 51, and the phosphor layer 582 layered at the reflection layer 581 at the side opposite from the substrate 51.

According to the configuration described above, the wavelength converting apparatus 5B can be configured as a stable reflective wavelength converting apparatus.

In the wavelength converting apparatus 5B, when the amount of substance of tin is 1 in the molar composition ratio of the tin oxide that constitutes the diffusion suppressing layer 59, the amount of substance of oxygen is greater than or equal to 1.1 but smaller than or equal to 2.0.

According to the configuration described above, the diffusion suppressing layer 59 contains tin dioxide. The diffusion suppressing layer 59 containing tin dioxide can effectively suppress the diffusion of the copper atoms, and can therefore enhance the adhesion between the diffusion suppressing layer 59 and the joining layer 57. The wavelength converter 58 can therefore be stably joined to the substrate 51, so that a stable wavelength converting apparatus 5B can be configured.

In the wavelength converting apparatus 5B, the tin oxide that constitutes the diffusion suppression layer 59 includes tin oxide having a rutile-type crystal structure.

The tin oxide having a rutile-type crystal structure is tin dioxide. The diffusion suppressing layer 59 therefore contains tin dioxide. The diffusion suppressing layer 59 containing tin dioxide can effectively suppress the diffusion of the copper atoms, as described above, and can therefore enhance the adhesion between the diffusion suppressing layer 59 and the joining layer 57. The wavelength converter 58 can therefore be stably joined to the substrate 51, so that a stable wavelength converting apparatus 5B can be configured.

In the wavelength converting apparatus 5B, the diffusion suppressing layer 59 has the thickness of 30 nm or greater.

According to the configuration described above, the diffusion of the copper atoms into the joining layer 57 can be reliably suppressed. The joining layer 57 can therefore join the wavelength converter 58 and the substrate 51 to each other with increased joining strength, so that a stable wavelength converting apparatus 5B can be configured.

In the wavelength converting apparatus 5B, the joining layer 57 contains any one of silver, gold, platinum, and palladium, and includes the first joining layer 571 layered at the diffusion suppressing layer 59. In the present embodiment, the first joining layer 571 contains silver.

The configuration described above can suppress the diffusion of the copper atoms from the substrate 51 into the first joining layer 571 layered at the diffusion suppressing layer 59.

In addition, since the tin oxide layer that constitutes the diffusion suppressing layer 59 intimately adheres to the joining layer 57 including the first joining layer 571, the joining layer 57 can join the wavelength converter 58 and the substrate 51 to each other with increased joining strength. A stable wavelength converting apparatus 5B can therefore be configured.

In the wavelength converting apparatus 5B, the joining layer 57 includes the second joining layer 572 and the third joining layer 573 as well as the first joining layer 571.

The second joining layer 572 is layered at the first joining layer 571 and contains silver nanoparticles.

The third joining layer 573 is layered at the second joining layer 572 and contains any one of silver, gold, platinum, and palladium. In the present embodiment, the third joining layer 573 contains silver.

According to the configuration described above, since the joining layer 57 includes the second joining layer 572 described above and the third joining layer 573 described above as well as the first joining layer 571 described above, the joining layer 57 can join the wavelength converter 58 and the substrate 51 to each other with increased joining strength. A stable wavelength converting apparatus 5B can therefore be configured.

In the wavelength converting apparatus 5B, the substrate 51 includes the base 52 and the copper oxide layer 53.

The base 52 is made of either copper or a copper alloy, and the copper oxide layer 53 is formed at the base 52. At least a part of the first surface 511 of the substrate 51 is configured with the copper oxide layer 53.

According to the configuration described above, since the adhesion of the diffusion suppressing layer 59 to the substrate 51 can be enhanced by the copper oxide layer 53, the wavelength converter 58 can be joined to the substrate 51 with increased joining strength.

### Variations of Embodiments

The present disclosure is not limited to the embodiments described above, and variations, improvements, and other modifications to the extent that the advantage of the present disclosure is achieved fall within the scope of the present disclosure.

In the embodiments described above, the wavelength converter 58 includes the reflection layer 581 disposed in the wavelength converter 58 at the side facing the base 52, and the phosphor layer 582 layered at the reflection layer 581 at the side opposite from the base 52. That is, the wavelength converting apparatuses 5A and 5B are reflective wavelength converting apparatuses that output converted light into which the excitation light is converted in terms of wavelength in the opposite direction of the direction in which the excitation light is incident, but not necessarily. The wavelength converter 58 may not include the reflection layer 581. That is, the wavelength converting apparatuses 5A and 5B may be configured as transmissive wavelength converting apparatuses that output converted light along the direction in which the excitation light is incident.

In the embodiments described above, the joining layer 57 includes the first joining layer 571 disposed at the side of the base 52 that is opposite from the joining reinforcing layer 56 or the diffusion suppressing layer 59 and layered at the joining reinforcing layer 56. It is further assumed that the first joining layer 571 contains any one of silver, gold, platinum, and palladium, but not necessarily. The joining layer 57 may contain metal other than silver, gold, platinum, and palladium. The joining layer 57 may include only the first joining layer 571.

It is assumed in the embodiments described above that the joining layer 57 includes, in addition to the first joining layer 571, the second joining layer 572 layered at the first joining layer 571 and containing silver nanoparticles, and the third joining layer 573 layered at the second joining layer 572 and containing any one of silver, gold, platinum, and palladium, but not necessarily. The second joining layer 572 may contain metal nanoparticles other than silver nanoparticles. The third joining layer 573 may contain metal other than silver, gold, platinum, and palladium, and may contain metal different from that contained in the first joining layer 571. Furthermore, the joining layer 57 may not include the third joining layer 573 but may include the first joining layer 571 and the second joining layer 572. In addition, the joining layer 57 may further include a joining layer having other characteristics different from those of the first joining layer 571, the second joining layer 572, and the third joining layer 573.

It is assumed in the first embodiment described above that the thickness of the joining reinforcing layer 56 is 10 nm or greater, preferably 20 nm or greater, but not necessarily. The thickness of the joining reinforcing layer 56 may be small than 10 nm as long as the joining layer can adequately ensure the strength of the joining between the base and the wavelength converter.

In the second embodiment described above, the thickness of the diffusion suppressing layer 59 is 25 nm or greater, preferably 30 nm or greater, but not necessarily. The thickness of the diffusion suppressing layer 59 may be smaller than 25 nm as long as the movement of the copper atoms from the substrate 51 into the joining layer 57 can be suppressed.

It is assumed in the first embodiment described above that when the amount of substance of tin is 1 in the molar composition ratio in the tin oxide that constitutes the joining reinforcing layer 56, the amount of substance of oxygen is greater than or equal to 1.3 but smaller than or equal to 2.0.

That is, it is assumed that the joining reinforcing layer 56 contains tin dioxide. The aforementioned molar composition ratio of the tin oxide that constitutes the joining reinforcing layer 56 can be changed as appropriate as long as the strength of the adhesion between the joining reinforcing layer and the joining layer can be higher than necessary adhesion strength and the strength of the joining between the base and the wavelength converter via the joining layer can be sufficiently ensured. For example, the amount of substance of oxygen may be greater than or equal to 1.0 but smaller than 1.3. That is, the joining reinforcing layer 56 may not contain tin dioxide having a rutile-type crystal structure.

It is assumed in the second embodiment described above that when the amount of substance of tin is 1 in the molar composition ratio in the tin oxide that constitutes the diffusion suppressing layer 59, the amount of substance of oxygen is greater than or equal to 1.1 but smaller than or equal to 2.0. That is, it is assumed that the diffusion suppressing layer 59 contains tin dioxide. The aforementioned molar composition ratio of the tin oxide that constitutes the diffusion suppressing layer 59 can be changed as appropriate as long as the strength of the adhesion between the diffusion suppressing layer and the joining layer can be higher than necessary adhesion strength and the strength of the joining between the base and the wavelength converter via the joining layer can be sufficiently ensured. For example, the amount of substance of oxygen may be greater than or equal to 1.0 but smaller than 1.1. That is, the diffusion suppressing layer 59 may not contain tin dioxide having a rutile-type crystal structure.

In the embodiments described above, the projector 1 includes the three light modulators 343R, 343G, and 343B, but not necessarily. The present disclosure is also applicable to a projector including two or fewer or four or greater number of light modulators.

In the embodiments described above, the image projecting apparatus 3 is formed in a substantially L shape, as shown in FIG. 1, but not necessarily. The image projecting apparatus may be formed, for example, in a substantially U shape.

It is assumed in the embodiments described above that the light modulating apparatuses 34 includes transmissive liquid crystal panels each having a light incident surface and a light exiting surface different from each other, but not necessarily. The light modulating apparatuses 34 may include reflective liquid crystal panels each having a surface that serves both as the light incident surface and the light exiting surface. Furthermore, light modulating apparatuses each using any component other than a liquid-crystal-based component, such as a device using micromirrors, for example, a digital micromirror device (DMD), may be employed as long as the component is capable of modulating an incident luminous flux to form an image according to image information.

It is assumed in the embodiments described above that the light source apparatus 4 is used in the projector 1, but not necessarily. The light source apparatus according to the present disclosure may be used for lighting equipment, a headlight of an automobile, or the like.

### Summary of Present Disclosure

The present disclosure will be summarized below as additional remarks.

### Additional Remark 1

A wavelength converting apparatus including:
a base made of one of copper and a copper alloy;
a copper oxide layer formed at a first surface of the base;
a joining reinforcing layer being a tin oxide layer which contains tin oxide and is layered at the copper oxide layer;
a joining layer disposed at the joining reinforcing layer; and
a wavelength converter disposed at the joining layer.

The configuration described above, in which the copper oxide layer is formed at the first surface of the base, can suppress deterioration of the base made of copper or a copper alloy.

Furthermore, the configuration in which the joining reinforcing layer, which is a tin oxide layer, is layered at the copper oxide layer can enhance the adhesion between the joining reinforcing layer and the joining layer, and hence the adhesion between the base and the joining layer.

The strength of the joining between the wavelength converter and the base via the joining layer can therefore be increased, so that a stable wavelength converting apparatus can be configured.

### Additional Remark 2

The wavelength converting apparatus according to the additional remark 1, wherein
the wavelength converter includes
a reflection layer disposed in the wavelength converter at a side facing the base, and
a phosphor layer layered at the reflection layer at a side opposite from the base.

According to the configuration described above, in which the wavelength converter includes the reflection layer and the phosphor layer, the wavelength converting apparatus can be configured as a stable reflective wavelength converting apparatus.

### Additional Remark 3

The wavelength converting apparatus according to the additional remark 1 or 2, wherein
the joining layer includes a first joining layer layered at the joining reinforcing layer and containing any one of silver, gold, platinum, and palladium.

Since the tin oxide layer that constitutes the joining reinforcing layer intimately adheres to the joining layer including the first joining layer described above, the joining layer can join the wavelength converter and the base to each other with increased joining strength. A stable wavelength converting apparatus can therefore be configured.

### Additional Remark 4

The wavelength converting apparatus according to the additional remark 3, wherein
the joining layer includes
a second joining layer layered at the first joining layer and containing silver nanoparticles, and
a third joining layer layered at the second joining layer and containing any one of silver, gold, platinum, and palladium.

According to the configuration described above, since the joining layer includes the second joining layer described above and the third joining layer described above as well as the first joining layer described above, the joining layer can join the wavelength converter and the base to each other with increased joining strength. A stable wavelength converting apparatus can therefore be configured.

### Additional Remark 5

The wavelength converting apparatus according to any one of the additional remarks 1 to 4, wherein
the joining reinforcing layer has a thickness of 10 nm or greater.

The configuration described above, in which the joining reinforcing layer containing tin oxide can be formed as a continuous layer, can increase the strength of the joining between the joining reinforcing layer and the joining layer. A stable wavelength converting apparatus can therefore be configured.

### Additional Remark 6

The wavelength converting apparatus according to the additional remark 5, wherein
the joining reinforcing layer has a thickness of 20 nm or greater.

The configuration described above, in which the strength of the joining between the joining reinforcing layer and the joining layer can be further increased, can stably join the wavelength converter to the base. A stable wavelength converting apparatus can therefore be configured.

### Additional Remark 7

The wavelength converting apparatus according to any one of the additional remarks 1 to 6, wherein when an amount of substance of tin is 1 in a molar composition ratio of the tin oxide that constitutes the joining reinforcing layer, an amount of substance of oxygen is greater than or equal to 1.3 but smaller than or equal to 2.0.

According to the configuration described above, the joining reinforcing layer contains tin dioxide. The strength of the adhesion between the joining reinforcing layer, which is a tin oxide layer, and the joining layer can thus be increased, so that the wavelength converter can be stably joined to the base. A stable wavelength converting apparatus can therefore be configured.

### Additional Remark 8

A wavelength converting apparatus including:
a substrate having a first surface and made of one of copper and a copper alloy;
a diffusion suppressing layer containing tin oxide and disposed at the first surface;
a joining layer disposed at the diffusion suppressing layer; and
a wavelength converter disposed at the joining layer.

According to the configuration described above, in the process of joining the wavelength converter to the substrate via the joining layer, the diffusion of the copper atoms from the substrate into the joining layer can be suppressed by the diffusion suppressing layer containing tin oxide. The configuration described above can suppress a decrease in the joining force of the joining layer caused by diffusion of copper atoms into the joining layer. The joining layer can therefore join the wavelength converter and the substrate to each other with increased joining strength, so that a stable wavelength converting apparatus can be configured.

### Additional Remark 9

The wavelength converting apparatus according to the additional remark 8, wherein
the wavelength converter includes
a reflection layer disposed in the wavelength converter at a side facing the substrate, and
a phosphor layer layered at the reflection layer at a side opposite from the substrate.

According to the configuration described above, in which the wavelength converter includes the reflection layer and the phosphor layer, the wavelength converting apparatus can be configured as a stable reflective wavelength converting apparatus.

### Additional Remark 10

The wavelength converting apparatus according to the additional remark 8 or 9, wherein
when an amount of substance of tin is 1 in a molar composition ratio of the tin oxide that constitutes the diffusion suppressing layer, an amount of substance of oxygen is greater than or equal to 1.1 but smaller than or equal to 2.0.

According to the configuration described above, the diffusion suppressing layer contains tin dioxide. The diffusion suppressing layer containing tin dioxide can effectively suppress the diffusion of the copper atoms, and can therefore enhance the adhesion between the diffusion suppressing layer and the joining layer. The wavelength converter can therefore be stably joined to the substrate, so that a stable wavelength converting apparatus can be configured.

### Additional Remark 11

The wavelength converting apparatus according to the additional remark 8 or 9, wherein
the tin oxide that constitutes the diffusion suppressing layer includes tin oxide having a rutile-type crystal structure.

The tin oxide having a rutile-type crystal structure is tin dioxide. The diffusion suppressing layer therefore contains tin dioxide. The diffusion suppressing layer containing tin dioxide can effectively suppress the diffusion of the copper atoms, as described above, and can therefore enhance the adhesion between the diffusion suppressing layer and the joining layer. The wavelength converter can therefore be stably joined to the substrate, so that a stable wavelength converting apparatus can be configured.

### Additional Remark 12

The wavelength converting apparatus according to the additional remark 10 or 11, wherein
the diffusion suppressing layer has a thickness of 30 nm or greater.

According to the configuration described above, the diffusion of the copper atoms into the joining layer can be reliably suppressed. The joining layer can therefore join the wavelength converter and the substrate to each other with increased joining strength, so that a stable wavelength converting apparatus can be configured.

### Additional Remark 13

The wavelength converting apparatus according to any one of the additional remarks 8 to 12, wherein
the joining layer includes a first joining layer containing any one of silver, gold, platinum, and palladium and layered at the diffusion suppressing layer.

The configuration described above can suppress the diffusion of the copper atoms from the substrate into the first joining layer layered at the diffusion suppressing layer.

In addition, since the tin oxide layer that constitutes the diffusion suppressing layer intimately adheres to the joining layer including the first joining layer described above, the joining layer can join the wavelength converter and the substrate to each other with increased joining strength. A stable wavelength converting apparatus can therefore be configured.

### Additional Remark 14

The wavelength converting apparatus according to the additional remark 13, wherein
the joining layer includes
a second joining layer layered at the first joining layer and containing silver nanoparticles, and
a third joining layer layered at the second joining layer and containing any one of silver, gold, platinum, and palladium.

According to the configuration described above, since the joining layer includes the second joining layer described above and the third joining layer described above as well as the first joining layer described above, the joining layer can join the wavelength converter and the substrate to each other with increased joining strength. A stable wavelength converting apparatus can therefore be configured.

### Additional Remark 15

The wavelength converting apparatus according to any one of the additional remarks 8 to 14, wherein
the substrate includes
a base made of one of copper and a copper alloy, and
a copper oxide layer formed at the base, and
at least a part of the first surface is configured with the copper oxide layer.

According to the configuration described above, since the adhesion of the diffusion suppressing layer to the substrate can be enhanced by the copper oxide layer, the wavelength converter can be joined to the substrate with increased joining strength.

### Additional Remark 16

A light source apparatus including:
a solid-state light source configured to output excitation light; and
the wavelength converting apparatus according to any one of the additional remarks 1 to 15 configured to convert a wavelength of the excitation light.

The configuration described above provides the same effects as those provided by the wavelength converting apparatus described above. A light source apparatus capable of stably outputting light can thus be configured.

### Additional Remark 17

A projector including:
the light source apparatus according to the additional remark 16;
an image light generating apparatus configured to generate image light from light from the light source apparatus; and
a projection optical apparatus configured to project the generated image light.

The configuration described above provides the same effects as those provided by the light source apparatus described above. A projector capable of stably projecting image light can thus be configured.

What is claimed is:

1. A wavelength converting apparatus comprising:
a base made of one of copper and a copper alloy;
a copper oxide layer formed at a first surface of the base;
a joining reinforcing layer being a tin oxide layer which contains tin oxide and is layered at the copper oxide layer;
a joining layer disposed at the joining reinforcing layer; and
a wavelength converter disposed at the joining layer.

2. The wavelength converting apparatus according to claim 1, wherein
the wavelength converter includes
a reflection layer disposed at a base side with respect to the wavelength converter, and
a phosphor layer layered at the reflection layer at a side opposite from the base.

3. The wavelength converting apparatus according to claim 1, wherein
the joining layer includes a first joining layer layered at the joining reinforcing layer and containing one of silver, gold, platinum, and palladium.

4. The wavelength converting apparatus according to claim 3, wherein
the joining layer includes
a second joining layer layered at the first joining layer and containing silver nanoparticles, and
a third joining layer layered at the second joining layer and containing one of silver, gold, platinum, and palladium.

5. The wavelength converting apparatus according to claim 1, wherein
the joining reinforcing layer has a thickness of 10 nm or greater.

6. The wavelength converting apparatus according to claim 5, wherein
the joining reinforcing layer has a thickness of 20 nm or greater.

7. The wavelength converting apparatus according to claim 1, wherein
when an amount of substance of tin is 1 in a molar composition ratio of the tin oxide that constitutes the joining reinforcing layer, an amount of substance of oxygen is greater than or equal to 1.3 but smaller than or equal to 2.0.

8. A wavelength converting apparatus comprising:
a substrate having a first surface and made of one of copper and a copper alloy;
a diffusion suppressing layer containing tin oxide and disposed at the first surface;
a joining layer disposed at the diffusion suppressing layer; and
a wavelength converter disposed at the joining layer.

9. The wavelength converting apparatus according to claim 8, wherein
the wavelength converter includes
a reflection layer disposed at a substrate side with respect to the wavelength converter, and
a phosphor layer layered at the reflection layer at a side opposite from the substrate.

10. The wavelength converting apparatus according to claim 8, wherein
when an amount of substance of tin is 1 in a molar composition ratio of the tin oxide that constitutes the diffusion suppressing layer, an amount of substance of oxygen is greater than or equal to 1.1 but smaller than or equal to 2.0.

11. The wavelength converting apparatus according to claim 10, wherein
the diffusion suppressing layer has a thickness of 30 nm or greater.

12. The wavelength converting apparatus according to claim 8, wherein
the tin oxide that constitutes the diffusion suppressing layer includes tin oxide having a rutile-type crystal structure.

13. The wavelength converting apparatus according to claim 12, wherein
the diffusion suppressing layer has a thickness of 30 nm or greater.

14. The wavelength converting apparatus according to claim 8, wherein
the joining layer includes a first joining layer containing one of silver, gold, platinum, and palladium and layered at the diffusion suppressing layer.

15. The wavelength converting apparatus according to the claim 14, wherein
the joining layer includes
a second joining layer layered at the first joining layer and containing silver nanoparticles, and
a third joining layer layered at the second joining layer and containing one of silver, gold, platinum, and palladium.

16. The wavelength converting apparatus according to claim 8, wherein
the substrate includes
a base made of one of copper and a copper alloy, and
a copper oxide layer formed at the base, and
at least a part of the first surface is configured with the copper oxide layer.

17. A light source apparatus comprising:
a solid-state light source configured to emit excitation light; and
the wavelength converting apparatus according to claim 1 configured to convert a wavelength of the excitation light.

18. A light source apparatus comprising:
a solid-state light source configured to emit excitation light; and
the wavelength converting apparatus according to claim 8 configured to convert a wavelength of the excitation light.

19. A projector comprising:
the light source apparatus according to claim 17;
an image light generating apparatus configured to generate image light from light emitted from the light source apparatus; and
a projection optical apparatus configured to project the generated image light.

20. A projector comprising:
the light source apparatus according to claim 19;
an image light generating apparatus configured to generate image light from light emitted from the light source apparatus; and
a projection optical apparatus configured to project the generated image light.
